(19) United States
(12) Patent Application Publication
(10) Pub. No.: US 2006/0188997 A1
(43) Pub. Date: Aug. 24, 2006

(54) Detection of superoxide ions

(75) Inventors: Jonathan J. Abramson, Beaverton, OR (US); Rotimi O. Olojo, Portland, OR (US)

Correspondence Address: KLARQUIST SPARKMAN, LLP, 121 SW SALMON STREET, SUITE 1600, PORTLAND, OR, 97204, US

(73) Assignee: Portland State University

(21) Appl. No.: 11/340,938

(22) Filed: Jan. 27, 2006

Related U.S. Application Data
(60) Provisional application No. 60/648,351, filed on Jan. 28, 2005.

(51) Int. Cl. G01N 31/22

(52) U.S. Cl. 436/164

(57) ABSTRACT

Two highly sensitive spectrophotometric methods are developed and described for the measurement of superoxide ion radical derived from KO₂ as well as O₂^{.-} generated from either the xanthine-xanthine oxidase reaction or by the addition of NADH to skeletal muscle sarcoplasmic reticulum (SR) vesicles. These methods allow quantification of superoxide ion concentration by monitoring its reaction with 4-Chloro-7-nitrobenzo-2-oxa-1,3-diazole, (NBD-Cl), either by recording absorbance of the final reaction product at a wavelength of 470 nm or by measuring its fluorescence emission intensity at 550 nm using an excitation wavelength of 470 nm. The extinction coefficient of the active product was determined to be 4000 M⁻¹ cm⁻¹. A lower limit second-order bimolecular rate constant of 1.5±0.3×10⁵ M⁻¹ s⁻¹ was estimated from kinetic stopped-flow analysis for the reaction between NBD-Cl and KO₂. A plot of absorbance versus concentration of superoxide was linear over the range 2-200 μM KO₂ while higher sensitivities were obtained from fluorometric measurements down into sub-micromolar concentrations with a limit of detection of 100 nM KO₂. This new spectrophotometric assay showed higher specificity when compared to some other commonly used methods for detection of superoxide (i.e. nitroblue tetrazolium). Results presented showed good experimental agreements with rates obtained for the measurement of superoxide ion when compared to other well known probes such as acetylated ferri cytochrome-C and XTT. A detailed discussion of the advantages and limitations of this new superoxide ion probe is presented.

### CROSS REFERENCE TO RELATED APPLICATION

This application claims the benefit of the earlier filing date of currently pending U.S. Provisional Application No. 60/648,351, filed Jan. 28, 2005.

### STATEMENT OF GOVERNMENT SUPPORT

This invention was made with government support from the National Institutes of Health; contract number R01 AR 48911-01. The government has certain rights in the invention.

### BRIEF DESCRIPTION OF THE DRAWINGS

FIG 1a: Absorption spectra generated from NBD-Cl in the presence and absence of superoxide ions. Individual spectrum shown is a difference spectrum obtained by measuring blank with all but the last listed specie in solvent medium specified at every condition. (a) [NBD-Cl]=100 μM in DMSO. (b) NBD-Cl]=200 μM and [KO₂]=40 μM in DMSO and (c) SR=0.1 mg/ml; [NBD-Cl]=100 μM and [NADH]=40 μM in phosphate buffer at pH=7.4

FIG. 1b: Logarithmic plots for the reaction of different concentrations of KO₂ with fixed NBD-Cl concentrations. [NBD-Cl]=100 μM and linear plot of absorbance versus [KO₂] gives molar absorptivity, ε_{470 nm}=4000 M⁻¹ cm⁻¹. All measurements were carried out in DMSO.

FIG. 2: Determination of optimum concentration of NBD-Cl by varying amounts of NBD-Cl present at fixed concentration of the xanthine-xanthine oxidase reaction. [Xanthine]=50 μM; [Xanthine Oxidase]=50 nM; [NBD-Cl]=0−500 μM and ε_{470 nm}=4000 M⁻¹ cm⁻¹. All measurements were carried out in phosphate buffer at pH 7.4.

FIG. 3: Determination of reaction specificity of NBD-Cl for O₂^{.-} by measuring inhibition of signal generated at 470 nm using SOD at varying concentrations. [Xanthine]=50 μM; [Xanthine Oxidase]=150 nM and [NBD-Cl]=100 μM. All measurements were carried out in phosphate buffer at pH=7.4

FIG. 4: Time-dependent profile for NBD-Cl reaction with superoxide at 470 nm in xanthine-xanthine oxidase reaction. [Xanthine]=15 μM; [Xanthine Oxidase]=100 nM and [NBD-Cl]=100 μM. Final absorbance =0.047; ε_{470 nm}=4000 M⁻¹ cm⁻¹ and calculated [O₂^{.-}]=12 μM. Insert A shows time-dependent profile for uric acid formation at 295 nm measured under identical conditions in the absence of NBD-Cl. ε_{295 nm}=1.22×10⁴ M⁻¹ cm⁻¹. Insert B shows xanthine-xanthine oxidase reaction followed at 470 nm under the same concentrations described above but using 600 μM XTT as probe. All measurements were made in phosphate buffer at pH 7.4.

FIG. 5: A typical reaction profile showing NBD-Cl used as a probe for measuring superoxide ion generated with sarcoplasmic reticulum (SR) vesicles and NADH. SR=0.1 mg/mL, [NBD-Cl]=100 μM and [NADH]=40 μM. Measurement was carried out in phosphate buffer at pH 7.4.

FIG. 6: Calibration curve for the measurement of superoxide ion concentration from fluorescence emission of NBD product. Excitation wavelength=470 nm (slit width=2.5 mm); Emission wavelength=550 nm (slit width=1.25 mm). All measurements were made from mixtures prepared by adding 2 volumes of pure acetonitrile to 1 volume of aqueous sample.

### DETAILED DESCRIPTION

Abbreviations used: 4-Chloro-7-nitrobenzo-2-oxa-1,3-diazole (NBD-Cl), Superoxide Dismutase (SOD), Nitroblue tetrazolium (NBT), (2,3-bis(2-methoxy-4nitro-5-sulphophenyl)-5-[(phenylamino)carbonyl]-2H-tetrazolium hydroxide, sodium salt, (XTT)

A new specific probe for detecting superoxide using either spectrophotometric or fluorimetric techniques has been developed. The probe, 4-chloro-7-nitrobenzo-2-oxa-13-diazole, or NBD-Cl, upon reacting with superoxide, shows a rapid increased absorbance at 470 nm. Upon excitation at 470 nm, the NBD-Cl-superoxide product fluoresces at 540 nm. This new probe is more specific than other probes commonly used for detecting superoxide. A plot of absorbance vs. concentration of superoxide was linear over a range of superoxide concentrations from 2-200 μM. This probe is not sensitive to other commonly generated reactive Oxygen species, and appears to have several advantages to other commonly used optical probes for detecting superoxide.

The need for such a probe for detecting superoxide is large. Reactive oxygen species are generated in numerous biological systems. During normal metabolism superoxide is generated. During several biological events, such as aging, muscle fatigue, cardiac ischemia, and inflammation the levels of generating superoxide are elevated. As a consequence of superoxide production levels of peroxide, hydroxyl radicals and other reactive oxygen species increase. These elevated levels of reactive oxygen species appear to functionally alter numerous biological transport proteins and the integrity of biological membranes. There is a large need for a tool that enables researchers and other scientists to easily detect and quantify the cellular concentration of superoxide.

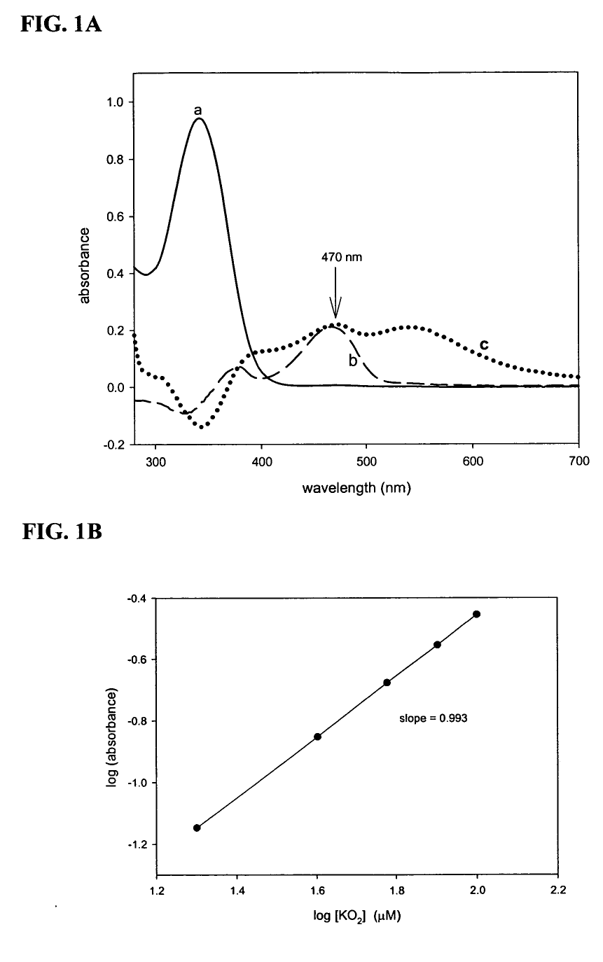

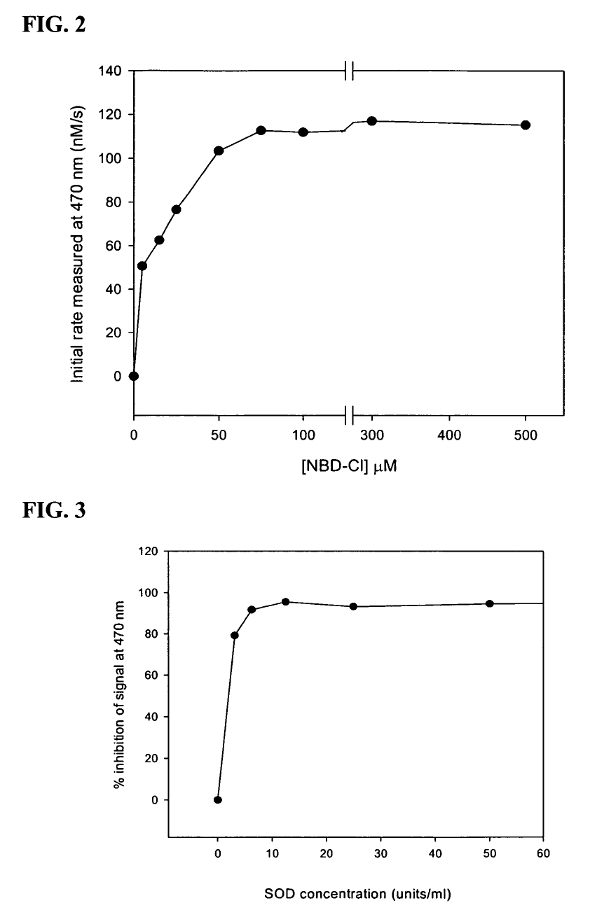

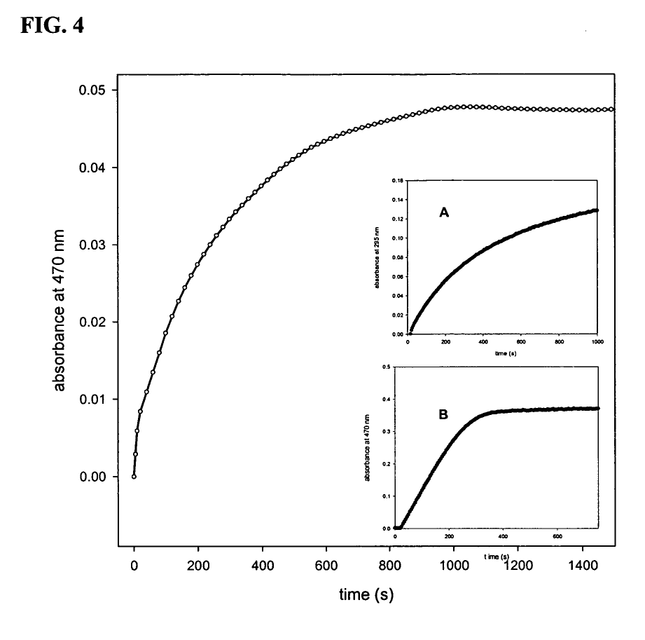

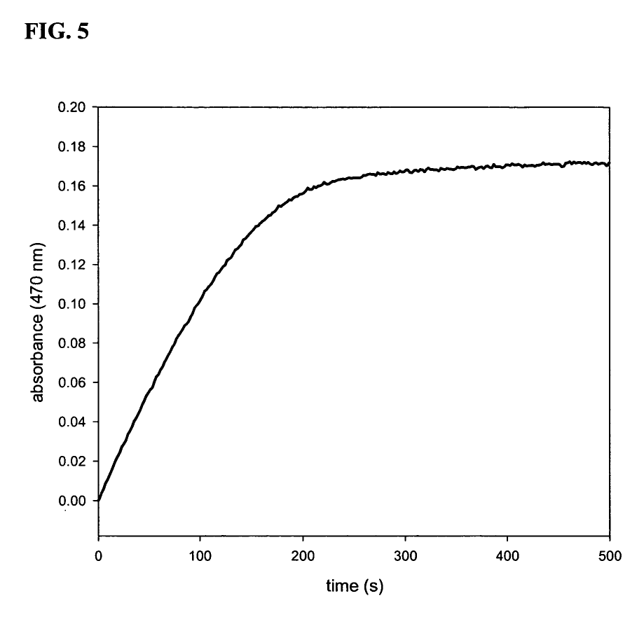

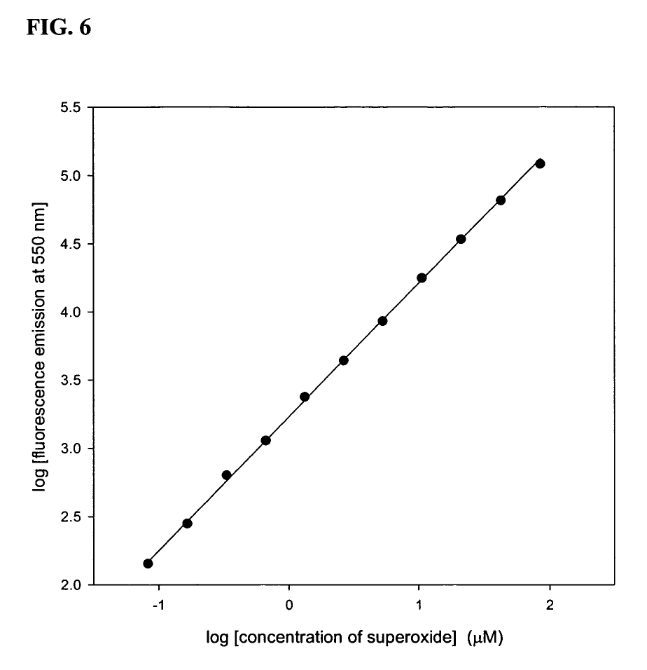

The detection and measurement of superoxide ion has been critical to the understanding of several biological events such as aging, muscle fatigue, ischemia-reperfusion and inflammation in living organisms [1-3]. Vascular dysfunction as observed in atherosclerosis, hypertension, diabetes as well as in postischemic myocardium have been implicated from alterations in both the rates of formation and the rates of scavenging of O₂^{.-} [4]. Efforts have been directed in recent years toward improving existing techniques for measuring this ubiquitous reactive oxygen species. Methods used for detecting O₂^{.-} include EPR spin trapping [5-7], spectrophotometry (cytochrome c [8] or nitro-substituted aromatics such as nitroblue tetrazolium [9]) and electrochemical detection using SOD-immobilized microelectrodes. However, several of these techniques have problems which limit sensitivity and specificity of the probe and difficulties in quantifying the amount or rate of O₂^{.-} detection. Many reduced forms of redox-active compounds are capable of reducing cytochrome c [10-11 ], while measurements with tetrazolium can be complicated by artificial O₂^{.-} formed from molecular oxygen and NBT radical species when working in aerobic conditions [12]. The superoxide ion probe presented in this work, 4-Chloro-7-nitrobenzo-2-oxa-1,3-diazole (NBD-Cl), has been well documented in its use for fluorescent detection of reactive thiols [13-15] as well as primary and secondary amines [16]. NBD-Cl has also been used for the quantification of an antidepressant, Dothiepin hydrochloride [17], which is widely used in treating endogenous depression, a state of depression for which there is no apparent precipitating cause. A more recent work used NBD-Cl as a derivatizing agent for lisinopril, a synthetic peptide anti-hypertensive drug [18]. In this work, we demonstrate that NBD-Cl can be use to rapidly detect and quantify superoxide ion production generated by a water soluble enzymatic system (xanthine, xanthine oxidase), a membrane bound NADH oxidase or in an organic solvent. 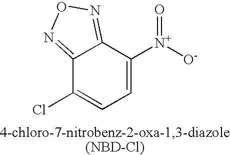
Experimental
Instrumentation:
Both a Lambda 25 Perkin-Elmer double beam and a HP 8452 spectrophotometer were used in the spectrophotometric measurements in this study. Rate of formation and absorbance measurements in the reaction between NBD-Cl and KO₂ in DMSO were obtained using a Hi-Tech SF-61 DX2 double-mixing stopped-flow spectrophotometer. Flourometric measurements were carried using a Spex Fluorolog 0.22 m double spectrometer using slit widths of 2.5 mm and 1.25 mm for the excitation and emission wavelengths respectively. Characterization of the product was carried out by setting the excitation wavelength at 470 nm and emission scans were performed between wavelength ranges of 480 nm and 680 nm.
Materials and Methods
4-Chloro-7-nitrobenzo-2-oxa-1,3-diazole (NBD-Cl) was purchased from Fluka. Ten millimolar stock solutions of NBD-Cl were prepared using acetonitrile as a solvent. The stock solution was stable in the dark for several days. Potassium superoxide (KO₂) was purchased from Aldrich and 10 mM solutions were prepared daily by dissolving weighed amount in DMSO and then vigorously stirred for about 15 minutes. All spectrophotometric measurements were carried out either in DMSO or phosphate buffer (50 mM KH₂PO₄ and 10 MM KCl) adjusted to pH 7.4. Xanthine solution was made fresh by dissolving xanthine in a minimal volume of 1 M KOH. This was followed by dilution with deionized water and adjusting the pH to 7.4 with 1 M HCl. Xanthine oxidase solution was prepared immediately before use in phosphate buffer. SR vesicles were isolated from rabbit fast twitch skeletal muscle by the method of MacLennnan [19] with small modifications. All buffers used in the isolation of the SR include addition of 50 μM dithiothreitol and 0.2μg/ml leupeptin except for the final SR resuspension buffer.
Results
NBD-Cl and Superoxide Ion Reaction
NBD-Cl has a characteristic absorption peak at 343 nm as shown FIG. 1a (trace ‘a’). The reaction between NBD-Cl and KO₂ both in DMSO and phosphate buffer produces a stable reaction product with a characteristic absorbance peak at 470 nm (FIG. 1a trace ‘b’). Trace b is a difference spectrum obtained by subtracting absorbance spectrum of NBD-Cl from its new spectrum following reaction with KO₂. Using DMSO as reaction medium, log-log plots [17] of the absorbance at 470 nm as function of either [NBD-Cl] or [KO₂] gave linear plot with slopes corresponding to a stoichiometry of 1:3 for NBD-Cl to O₂^{.-}, The calculated extinction coefficient from the measured absorbance is 4000±137 M⁻¹ cm⁻¹. The formation of the reaction product is extremely fast proceeding to completion in less than 1 s with a second-order rate constant of 1.5±0.3×10⁵M⁻¹ s⁻¹ recorded on a Hi-tech SF-61 DX2 stopped-flow spectrophotometer (data not shown). Thus, NBD-Cl can be used to rapidly detect and quantify superoxide ion. FIG. 1 a (trace c) showed a second absorption peak at 540 nm when NBD-Cl is used in quantification of superoxide ion in the presence of biological proteins. However, the presence of this peak does not enhance the absorbance measured at 470 nm. Addition experiments carried out (data not shown) revealed the existence of an isobestic point at around 485 nm. This allows the absorbance at 470 nm to remain constant even when absorbance at 540 nm fluctuates as we modify the protein environment. This conclusion is further substantiated by the fact that NBD-Cl assays at 470 nm from 40 μM KO₂ in DMSO as solvent and that measured from 40 μM NADH in the presence of SR gave the same final absorption value.
Xanthine-Xanthine Oxidase Reaction with NBD-Cl
The sensitivity of NBD-Cl for the detection of superoxide ion was optimized by using a fixed concentration of the xanthine/xanthine oxidase [20-21] and varying concentrations of NBD-Cl until an upper limiting rate of reduction was reached. Further increases in the initial concentration of NBD-Cl did not produce any further change in the maximum initial rates at the corresponding absorption wavelength of 470 nm. FIG. 2 reveals that a concentration of 100 μM NBD-Cl is optimum for the measurement of superoxide ion generated over a given period. The role of superoxide ion in these reactions is demonstrated in FIG. 3 where SOD concentrations greater than 10 U/mL was found to be sufficient for complete elimination of the signal at 470 nm. The xanthine-xanthine oxidase reaction affords slow generation of superoxide ion which allows efficient detection by NBD-Cl, in spite of the spontaneous dismutation of O₂^{.-} to peroxide that is observed in an aqueous environment. FIG. 4 shows a typical time dependent absorbance trace obtained at 470 nm using NBD-Cl as a probe upon addition of 15 μM xanthine and 100 nM xanthine oxidase. The maximum absorbance of 0.048 corresponds to a measured amount of superoxide ion equal to 12.0 μM. Xanthine oxidase converts one mole of xanthine and O₂ to one mole of uric acid with the generation of superoxide ion. Using the extinction coefficient ε₄₇₀=4000 M⁻¹ cm⁻¹, O₂^{.-} generated is quantified by NBD-Cl. FIG. 4 (insert A) shows absorbance-time profile obtained when production of uric acid is followed at 295 nm from xanthine-xanthine oxidase reaction in the absence of any O₂^{.-} probe. This reaction profile suggests clearly that addition of NBD-Cl has slight activating effect on the reaction dynamics leading to the formation of uric acid based on comparison of time required to completely react with all of the xanthine present. However, replacement of NBD-Cl with XTT as an O₂^{.-} probe (FIG. 4, insert B) shows about a two-fold increase in the rate of superoxide ion formation, showing that XTT to a significant extent, activates the enzymatic production of O₂^{.-} during the xanthine-xanthine oxidase reaction. A comparative study involving measurement of initial rates of superoxide ion formation in xanthine-xanthine oxidase reaction using NBD-Cl, NBT-Cl, XTT and cytochrome C (acetylated) as O₂^{.-} probes is illustrated in Table 1. The results showed there is closer agreement in measurements obtained for NBD-Cl and cytochrome C while NBT-Cl presented specificity problems as previously documented.
SR/NADH Assay
Generation of superoxide ion by SR and NADH [3] was assayed using XTT, cytochrome C and NBD-Cl by following absorbance for both XTT and NBD-Cl at 470 nm and 550 nm for cytochrome C. Using extinction coefficients (mM⁻¹ cm⁻¹) of 21.6 for XTT [22], 4.0 for NBD-Cl ( this work) and 21.0 for cytochrome C [12], the measured superoxide ion concentrations were 33.1 and 38.5 and 26.3 respectively, initiating each reaction with 40 μM of NADH as illustrated in FIG. 5. NBD-Cl was similar to XTT and cytochrome C as far as its ability to measure comparable amounts of superoxide ion. In the presence of superoxide dismutase, detection of superoxide ion by NBD-Cl was completely inhibited, showing that superoxide ion was responsible for the peak at 470 nm.
Fluorometric Assay
The product of the reaction between NBD-Cl and KO₂ has been shown to have a characteristic absorbance at 470 nm in aqueous environment. However, upon excitation at 470 nm in a fluorimeter, an emission was not observed except when organic solvent was present in the medium. Results show that by reducing the polarity of the reaction medium, the fluorescent intensity of the signal increased. An optimization of fluorescence signal was carried out by devising a new method for fluorometric assay for superoxide ion detected using NBD-Cl in aqueous medium. This was done by generating a calibration curve from varying concentrations of the NBD-Cl product from aqueous medium. By mixing 1 ml of this NBD product solution with 2 ml of organic solvent, the fluorescence signal was read at the emission peak of 550 nm. The recommended solvent for activating NBD-Cl product fluorescence is acetonitrile. The calibration curve is derived by plotting the fluorescence intensity at 550 nm as a function of the starting concentration of NBD-Cl product. Quantification of superoxide ion generated from other sources such as from xanthine-xanthine oxidase reaction and phenazine methosulfate—NADH reactions were measured by following the protocol described above and the unknown concentration was read off the calibration curve. A typical calibration obtained is shown in FIG. 6 using 100 μM of NBD-Cl and different concentrations of KO₂. Concentrations were found to be linear in the measured range of 0.1 μM to 100 μM. This technique thus offers the ability of assaying superoxide through fluorometric measurement with NBD-Cl.
Discussion
Results presented in this study demonstrate that NBD-Cl is a good tool for measuring superoxide ion at conditions where non-specific reactions of NBD-Cl are minimized. It is important to note that NBD-Cl also react with amines and thiols although some of these reactions can be eliminated by controlling pH of the environment. Previous works have described that NBD-Cl will react with thiols and sulfenic acid, forming two adducts with different absorption properties in the UV-Vis region. [23] The RS-NBD adduct absorbs at ˜420 nm while RSO-NBD absorbs at ˜350 nm. [24] Tyrosyl and amine groups react with NBD-Cl favorably in alkaline pH where the absorption maxima then shift to 385 nm and 480 nm respectively. [25]
Another important feature of this probe is the large rate constant obtained between NBD-Cl and superoxide ion (1.5±0.3×10⁵ M⁻¹ s⁻¹) during kinetic stopped-flow measurements, suggesting that NBD-Cl can rapidly assay superoxide without significant interference from other non-specific reactions that may occur at a much slower time scales. The measured second-order rate constants (M⁻¹ s⁻¹) for cytochrome c and XTT reductions by O₂^{.-} are 4.82±0.73×10⁵ and 8.59±0.81×10⁴ respectively, in good agreement with data in FIGS. 4-6 showing NBD-Cl is as good or perhaps better scavenger of superoxide ion than comparable probes. A concentration of 100 μM NBD-Cl produces sufficiently low absorbance across the UV-Vis region which allows monitoring other species of interest especially in the regions between 250-500 nm conveniently. Use of XTT as a probe permits quantitative measurements of O₂^{.-} at wavelength region greater than 450 nm when working at the recommended concentration of 500-750 μM [26]. However, due to its large absorbance in the lower UV-Vis region, simultaneous measurements in the UV region of the spectra are difficult (i.e. such as monitoring oxidation of NADH at 340 nm). In addition, fluorometric measurements allow lower concentrations of superoxide ions to be detected with greater accuracy. Optimization of the fluorescence signal can be achieved by employing an organic solvent that yields a stable fluorescence signal. The higher the slope of the calibration curve, the lower the limit of detection of superoxide ion. Additional experiments (data not shown) confirmed that the presence of biological species such as H₂O₂, NADH, NADPH and NAD⁺ does not interfere with NBD-Cl reactions and especially its ability to quantify superoxide ion in solution. However, it is recommended that control experiments are performed when working in biological environments where NBD-Cl can readily react with a variety of compounds. In the presence of NBD-Cl, addition of NADH to sarcoplasmic reticulum vesicles (SR) showed superoxide ion formation at 470 nm that was completely inhibited by addition of SOD in aerobic conditions. At low oxygen (˜130 ppm), SR reduced NBD-Cl at rates comparable to that measured under aerobic conditions. This observation suggests that in the absence of molecular oxygen, SR passes electrons directly to NBD-Cl with little or no change in the rate of reduction of NBD-Cl. However, in the absence NBD-Cl, rates of oxidation of NADH by SR showed direct dependence on oxygen concentration. The ability of NBD-Cl to be reduced by species other than superoxide ions with formation of peak at 470 nm was confirmed using the short-chain sugars, glycolaldehyde (GLA) and DL-glyceraldehyde (GA) at a concentration of 50 mM. Under aerobic conditions, the reduction of NBD-Cl was observed by these sugars while addition of 100 U/ml SOD produced 50% and 66% inhibition of the 470 nm peak respectively. Similar observations have been reported earlier by Benov and Fridovich [27] where XTT was found to be reduced by short-chain sugars (GLA and GA) in the presence and absence of molecular oxygen.
Conclusion
NBD-Cl is a functional superoxide ion probe that compares well with popular probes such XTT and acetylated cytochrome C while offering an inexpensive technique for assaying superoxide ion in various systems. It offers a fast and efficient technique for measuring superoxide ion with reliable accuracy and sensitivity under aerobic conditions.

Table 1: Comparisons of initial rates from NBD-Cl with other well known probes such as cytochrome C and NBT-Cl in the xanthine-xanthine oxidase reaction.

TABLE 1
Comparison of initial rates (μM/s) of superoxide ion production
with NBD-Cl and other commonly used probes using xanthine-xanthine
oxidase reaction. [NBD-Cl] = [NBT-Cl] = 100 μM;
[Xanthine] = 50 μM; [Xanthine Oxidase] = 150 nM;
[Cytochrome C] = 80 μg/ml and XTT = 600 μM.
Extinction coefficients (mM⁻¹cm⁻¹) used for NBD-Cl,
NBT-Cl, Cytochrome C and XTT are 4.0, 15.0, 16.8 and 21.6
respectively at their indicated wavelengths. All measurements
were made in phosphate buffer at pH 7.4.

| | | | Superoxide |
|---|---|---|---|
| Xan./Xan. | Superoxide ion at | Superoxide ion | ion at |
| Ox. Reaction | 470 nm | at 550-540 nm | 550 nm |
| +NBD-Cl | 0.127 ± 0.002 | — | — |
| +CYTOCHROME-C | — | 0.101 ± 0. 007 | — |
| (acetylated) | | | |
| +NBT-Cl | — | — | 0.038 ± |
| | | | 0.002 |
| +XTT | 0.225 ± 0.010 | — | |

### Reference List

[1] K. Staniek, H. Nohl, H(2)O(2) detection from intact mitochondria as a measure for one-electron reduction of dioxygen requires a non-invasive assay system, Biochim. Biophys. Acta 1413 (1999) 70-80.
[2] L. Valgimigli, M. Valgimigli, S. Gaiani, G. F. Pedulli, L. Bolondi, Measurement of oxidative stress in human liver by EPR spin-probe technique, Free Radic. Res. 33 (2000) 167-178.
[3] R. Xia, J. A. Webb, L. L. Gnall, K. Cutler, J. J. Abramson, Skeletal muscle sarcoplasmic reticulum contains a NADH-dependent oxidase that generates superoxide, Am. J. Physiol Cell Physiol 285 (2003) C215-C221.
[4] R. Golfetti, T. Rork, G. Merrill, Chronically administered acetaminophen and the ischemia/reperfused myocardium, Exp. Biol. Med. (Maywood.) 228 (2003) 674-682.
[5] M. Dambrova, L. Baumane, I. Kalvinsh, J. E. Wikberg, Improved method for EPR detection of DEPMPO-superoxide radicals by liquid nitrogen freezing, Biochem. Biophys. Res. Commun. 275 (2000) 895-898.
[6] J. Vasquez-Vivar, B. Kalyanaraman, M. C. Kennedy, Mitochondrial aconitase is a source of hydroxyl radical. An electron spin resonance investigation, J. Biol. Chem. 275 (2000) 14064-14069.
[7] M. Valgimigli, L. Valgimigli, D. Trere, S. Gaiani, G. F. Pedulli, L. Gramantieri, L. Bolondi, Oxidative stress EPR measurement in human liver by radical-probe technique. Correlation with etiology, histology and cell proliferation, Free Radic. Res. 36 (2002) 939-948.
[8] M. Kelm, R. Dahmann, D. Wink, M. Feelisch, The nitric oxide/superoxide assay. Insights into the biological chemistry of the NO/O-2. interaction, J. Biol. Chem. 272 (1997) 9922-9932.
[9] S. Nagano, M. Umemoto, K. Kobayashi, A. Matsuoka, [Flow cytometric measurement of NBT-reducing activity in peripheral leukocytes applying THMS H. 1TM], Rinsho Byori 38 (1990) 794-798.
[10] A. M. Cassina, R. Hodara, J. M. Souza, L. Thomson, L. Castro, H. Ischiropoulos, B. A. Freeman, R. Radi, Cytochrome c nitration by peroxynitrite, J. Biol. Chem. 275 (2000) 21409-21415.
[11] L. Thomson, M. Trujillo, R. Telleri, R. Radi, Kinetics of cytochrome c2+ oxidation by peroxynitrite: implications for superoxide measurements in nitric oxide-producing biological systems, Arch. Biochem. Biophys. 319 (1995) 491-497.
[12] M. M. Tarpey, I. Fridovich, Methods of detection of vascular reactive species: nitric oxide, superoxide, hydrogen peroxide, and peroxynitrite, Circ. Res. 89 (2001) 224-236.
[13] N. C. Price, M. Cohn, R. H. Schirmer, Fluorescent and spin label probes of the environments of the sulfhydryl groups of porcine muscle adenylate kinase, J. Biol. Chem. 250 (1975) 644-652.
[14] O. D. Lopina, A. M. Rubtsov, A. A. Boldyrev, [Investigation of sarcoplasmic reticulum SH-groups], Biokhimiia. 44 (1979) 306-316.
[15] T. Stuchbury, M. Shipton, R. Norris, J. P. Malthouse, K. Brocklehurst, J. A. Herbert, H. Suschitzky, A reporter group delivery system with both absolute and selective specificity for thiol groups and an improved fluorescent probe containing the 7-nitrobenzo-2-oxa-1,3-diazole moiety, Biochem. J. 151 (1975) 417-432.
[16] R. Becker, [Fluorometric determination of glibornuride in plasma and serum using 7-chloro-4-nitrobenzo-2-oxa-1,3-diazole], Arzneimittelforschung. 27 (1977) 102-105.
[17] E. A. Taha, Kinetic spectrophotometric methods for the determination of dothiepin hydrochloride in bulk and in drug formulation, Anal. Bioanal. Chem. 376 (2003) 1131-1136.
[18] A. A. El Emam, S. H. Hansen, M. A. Moustafa, S. M. El Ashry, D. T. El Sherbiny, Determination of lisinopril in dosage forms and spiked human plasma through derivatization with 7-chloro-4-nitrobenzo-2-oxa-1,3-diazole (NBD-Cl) followed by spectrophotometry or HPLC with fluorimetric detection, J. Pharm. Biomed. Anal. 34 (2004) 35-44.
[19] D. H. MacLennan, Purification and properties of an adenosine triphosphatase from sarcoplasmic reticulum, J. Biol. Chem. 245 (1970) 4508-4518.
[20] V. Roubaud, S. Sankarapandi, P. Kuppusamy, P. Tordo, J. L. Zweier, Quantitative measurement of superoxide generation using the spin trap 5-(diethoxyphosphoryl)-5-methyl-1-pyrroline-N-oxide, Anal. Biochem. 247 (1997) 404-411.
[21] S. P. Sanders, S. J. Harrison, P. Kuppusamy, J. T. Sylvester, J. L. Zweier, A comparative study of EPR spin trapping and cytochrome c reduction techniques for the measurement of superoxide anions, Free Radic. Biol. Med. 16 (1994) 753-761.
[22] M. Jiang, J. Zhang, Water stress-induced abscisic acid accumulation triggers the increased generation of reactive oxygen species and up-regulates the activities of antioxidant enzymes in maize leaves, J. Exp. Bot. 53 (2002) 2401-2410.
[23] S. Carballal, R. Radi, M. C. Kirk, S. Barnes, B. A. Freeman, B. Alvarez, Sulfenic acid formation in human serum albumin by hydrogen peroxide and peroxynitrite, Biochemistry 42 (2003) 9906-9914.
[24] H. R. Ellis, L. B. Poole, Novel application of 7-chloro-4-nitrobenzo-2-oxa-1,3-diazole to identify cysteine sulfenic acid in the AhpC component of alkyl hydroperoxide reductase, Biochemistry 36 (1997) 15013-15018.
[25] A. A. Aboderin, E. Boedefeld, Reaction of chicken egg white lysozyme with 7-chloro-4-nitrobenz-2-oxa-1,3-diazole. II. Sites of modification, Biochim. Biophys. Acta 420 (1976) 177-186.
[26] M. W. Sutherland, B. A. Learmonth, The tetrazolium dyes MTS and XTT provide new quantitative assays for superoxide and superoxide dismutase, Free Radic. Res. 27 (1997) 283-289.
[27] L. Benov, I. Fridovich, Is reduction of the sulfonated tetrazolium 2,3-bis (2-methoxy-4-nitro-5-sulfophenyl)-2-tetrazolium 5-carboxanilide a reliable measure of intracellular superoxide production?, Anal. Biochem. 310 (2002) 186-190.

We claim:

1. A method for detecting superoxide ion, comprising:
exposing a solution comprising superoxide ion to 4-chloro-7-nitrobenzo-2-oxa-1,3-diazole;
measuring the light absorbance of the solution;
determining a superoxide ion concentration based on the light absorbance of the solution.
